(19) United States
(12) Patent Application Publication
(10) Pub. No.: US 2026/0105250 A1
(43) Pub. Date: Apr. 16, 2026

(54) GROUNDING MACHINE-LEARNING MODELS FOR SEGMENTING DATASETS

(71) Applicant: Adobe Inc., San Jose, CA (US)

(72) Inventors: Abhi Jain, Ratlam (IN); Vidit Bhatia, Modinagar (IN); Som Ranjan Satapathy, Bengaluru (IN); Shaddy Garg, Distt. Moga (IN); Priyanka Garg, Karnal (IN); Chhavi Bansal, Delhi (IN)

(73) Assignee: Adobe Inc., San Jose, CA (US)

(21) Appl. No.: 18/916,017

(22) Filed: Oct. 15, 2024

(51) Int. Cl. G06F 40/242; G06F 40/40

(52) U.S. Cl. CPC G06F 40/242; G06F 40/40

(57) ABSTRACT

Techniques for grounding machine-learning models for segmenting datasets are described. In an example, a processing device is operable to receive a natural language input specifying criteria for a segment of a dataset and prompt a machine-learning model to recommend a plurality of attributes from a dictionary of attributes based on the natural language input. The dictionary of attributes specifies corresponding descriptions and sample data for a plurality of distinct attributes identified among data profiles included in the dataset. The processing device is further operable to identify a recommended attribute from the plurality of attributes based on the criteria and the corresponding description and sample data included in the dictionary for each of the plurality of attributes and prompt the machine-learning model to output a logical relation including specific attribute values to form the segment based on the corresponding description and the sample data for recommended attribute.

### BACKGROUND

Data collected about a system or organization is analyzed to understand complex situations and guide informed decision-making. Conventional data analysis techniques are tedious and time-consuming, often overwhelming analysts with large amounts of information. Machine-learning models help automate aspects of data analysis by improving efficiency, avoiding mistakes, and preventing information overload. The usefulness of answers obtained from machine-learning models depends on carefully grounding the model. If a machine-learning model misinterprets the context of a query, efficiency is reduced by additional time and resources spent interacting with the model until a satisfactory answer is returned.

### SUMMARY

Techniques for grounding machine-learning models for segmenting datasets are described. Implementing the described techniques enables an example data analysis system to ground and configure machine-learning models to segment datasets more efficiently and accurately. The data analysis system automates the process of defining target segments in large datasets by enabling machine-learning models to infer target criteria for a segment from natural language inputs, and without implementing extensive training or prompting. The data analysis utilizes a segmentation module that configures a machine-learning model to identify relevant attributes for segmentation, initially by grounding the model using an attribute dictionary. The attribute dictionary comprehensively summarizes the attributes in the dataset to be useable in a prompt of the machine-learning models. The segmentation module prompts the machine-learning model to recommend relevant attributes from the dictionary, and then triggers the model to establish logical relations for creating the segments that satisfy the target criteria using one or more of the relevant attributes. The data analysis system manages a user interface that presents recommended attributes, logical relations, and follow-up questions to allow manual intervention to improve the accuracy of the segmentation process. The example data analysis system enhances the precision of audience targeting and saves time for marketing professionals and other data analysts to segment large datasets.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to ground machine-learning models for segmenting datasets as described herein.

FIG. 2 depicts an example implementation of a segmentation module of FIG. 1 in greater detail as employing techniques described herein for grounding machine-learning models for segmenting datasets.

FIG. 3 depicts an example implementation of a dictionary generator of FIG. 2 in greater detail as employing techniques described herein for grounding machine-learning models for segmenting datasets.

FIG. 4 depicts an example implementation of an attribute recommender of FIG. 2 in greater detail as employing techniques described herein for grounding machine-learning models for segmenting datasets.

FIG. 5 depicts an example implementation of a logical relator of FIG. 2 in greater detail as employing techniques described herein for grounding machine-learning models for segmenting datasets.

FIG. 6 depicts an example implementation of a follow-up module of FIG. 2 in greater detail as employing techniques described herein for grounding machine-learning models for segmenting datasets.

FIG. 7 is a flow diagram depicting an algorithm as a step-by-step procedure, which is performable by a processing device to ground machine-learning models for segmenting datasets.

FIG. 8 depicts an example graphical user interface controlled by the data analysis system of FIG. 1 to employ techniques described herein for grounding machine-learning models for segmenting datasets

FIG. 9 illustrates an example system including various components of an example device usable as any type of computing device as described and/or utilized with reference to FIGS. 1 to 8 to implement examples of the techniques described herein.

### DETAILED DESCRIPTION

### Overview

Data analysis is used by organizations and other entities to process large datasets to understand behavior, preferences, and trends. Analyzing this information helps control digital content output by computing devices, such as to create targeted marketing campaigns that effectively promote products and services. Successful campaigns grow a customer base by fostering engagement and increasing conversion rates in specific target segments. However, manual data analysis to identify segments of datasets is time-consuming and challenging due to the overwhelming quantity of potentially relevant data profiles. Machine-learning models, such as Large Language Models (LLMs), automate data analysis, improving efficiency, reducing errors, and preventing information overload. However, conventional use of LLMs introduces challenges, such as misinterpreting queries or providing inaccurate responses.

Conventional grounding techniques are insufficient for configuring LLMs to segment large datasets. Conventional prompt-based grounding, for instance, leads to inconsistent and inaccurate segments, as the prompts may include open-ended questions or not adequately capture segmentation criteria. Additionally, token limits of LLMs restrict a size of the prompts and the amount of data that can be processed from an input. Accordingly, a complete dataset in real-world scenarios often exceeds prompt limits, resulting in incomplete or less precise segments. Conventional grounding techniques are also ineffective in adapting to evolving datasets having complex attributes that change over time based on customer behavior.

Accordingly, techniques for grounding machine-learning models for segmenting datasets are described. The techniques are configurable to automate various tedious and complex tasks for grounding machine-learning models, such as LLMs, to determine segments of information collected about a system or organization. Consider a large dataset that contains thousands or even millions of individual data profiles. Each data profile contains various attributes and corresponding data values. Through proper grounding, the techniques enable a machine-learning model to define target segments with increased efficiency and accuracy, including the attributes and corresponding data values that satisfy segmentation criteria. The techniques enable segment definitions to be inferred from simple, natural language inputs and without training or prompting the machine-learning model to analyze each data profile in the dataset directly.

In at least one implementation, a data analysis system utilizes a segmentation module that uses a machine-learning model (e.g., an LLM) to deduce segmentation criteria from a natural language input received through a user interface. The segmentation module configures the machine-learning model to define a specific group of data profiles that is likely to satisfy initial criteria inferred from the natural language input.

To improve the accuracy and efficiency of the machine-learning model, the data analysis system initially grounds the model using an attribute dictionary. The attribute dictionary provides a structured and comprehensive overview of the dataset, enabling the machine-learning model to identify relevant attributes for segmentation. Within the attribute dictionary, descriptions and sample data are specified for distinct attributes prevalent among the dataset's data profiles. The dictionary includes maximum, minimum, or mean values for numerical attributes to describe the range of data values captured by the various data profiles. For string (e.g., textual) attributes, the dictionary includes representative strings shared among the data profiles. The dictionary organizes the data profiles into distinct categories, classes, or types of information, enabling the model to derive generally applicable answers for the complete dataset without processing each data profile individually.

In response to receiving a natural language input that describes criteria for a segment, the segmentation module prompts the machine-learning model to recommend a plurality of dictionary attributes relevant to the natural language input. The segmentation module applies similarity search techniques on the criteria to identify at least one recommended attribute along with a corresponding description and data obtained from the dictionary.

The segmentation module triggers the machine-learning model a second time using at least one recommended attribute, the description, and the corresponding data. The segmentation module prompts the machine-learning model to establish a logical relation for obtaining a segment of a large dataset, which satisfies the criteria inferred from the natural language input. The machine-learning model produces a logical relation that includes specific attribute values used to create the segment based on the corresponding description and sample data for the recommended attribute. The segmentation module causes the user interface to present the logical relation, including the specific attribute values recommended to form the segment.

The segmentation module presents the recommended attribute(s) and the logical relation in the user interface to allow manual intervention, boosting confidence in the machine-learning model grounding with the intended segmentation criteria, e.g., a specific campaign. The information presented in the user interface enables marketing professionals to quickly identify the highly relevant attributes for their campaigns, discover additional attributes, or remove less-relevant attributes, thereby saving time and enhancing precision in audience targeting. By displaying the logical relation with one or more initial recommended attributes in the user interface, the segmentation module improves the accuracy of the final attribute selection, which remains under the user's control.

To enhance the accuracy and comprehensiveness of the machine-learning model's response, the segmentation module automatically triggers the machine-learning model a third time to generate one or more follow-up questions. If the user finds the initially defined segment inadequate (e.g., too broad or too narrow), a follow-up question is selectable from the user interface to assist the user in improving the segmentation. When the natural language input is incomplete or lacks specificity available from the dataset, the segmentation module manages the user interface to suggest additional user inputs that refine the segment with more specific or additional attribute recommendations.

In response to a selection of one or more follow-up questions presented in the user interface, the segmentation module invokes the machine-learning model again to further analyze the attribute dictionary, derive an updated logical relation, and improve the segmentation initially derived from the natural language input. This iterative process allows a marketing professional to provide additional inputs for fine-tuning a segment to a specific marketing campaign that encompasses a group of highly relevant data profiles that are aligned with the campaign's objectives.

Using the attribute dictionary, a sequence of prompts, and follow-up questions to ground the machine-learning model helps the segmentation module to scale data analysis tasks for processing larger or smaller amounts of data without introducing further complexity. This scalability ensures that the system can handle large datasets and complex segmentation tasks. The attribute dictionary provides a comprehensive overview of data attributes, while the separate attribute and logical relation prompts ensure accurate attribute selection and segment definition. Follow-up questions and manual attribute selections aid in refining segments and understanding the underlying data, enhancing the effectiveness of marketing campaigns. By implementing these techniques, the data analysis system helps users to create precise and dynamic audience segments without causing a large machine-learning model to analyze thousands or millions of data profiles directly and without spending copious amounts of time training the model or crafting complex prompts.

### Term Examples

A “machine-learning model” refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

A “large language model” (LLM) is a type of machine-learning model that is designed to understand, generate, and interact with human language inputs at a large scale. These machine-learning models are trained on vast amounts of text data using deep learning techniques (e.g., neural networks) to learn patterns, nuances, and the structure of language. The use of the term “large” refers to both the size of the training data and also to the complexity and scale of the neural networks, which may include billions or even trillions of parameters.

LLMs are configurable to perform a wide range of language-related tasks without being explicitly programmed for each one. Examples of these tasks include text generation, translation, summarization, question answering, sentiment analysis, and natural language processing. To train an LLM, the underlying machine-learning model is provided with training data that includes examples of text to train and retrain the model to predict a next word in a sequence. Over time, the model, once trained, is configured to generate text that is coherent and contextually relevant, is configurable to mimic a style and content of the training data, and so forth. In this way, LLMs provide a foundational tool in artificial intelligence for understanding and generating human language, powering a wide range of applications from conversational agents to content creation tools.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Data Segmentation Environment

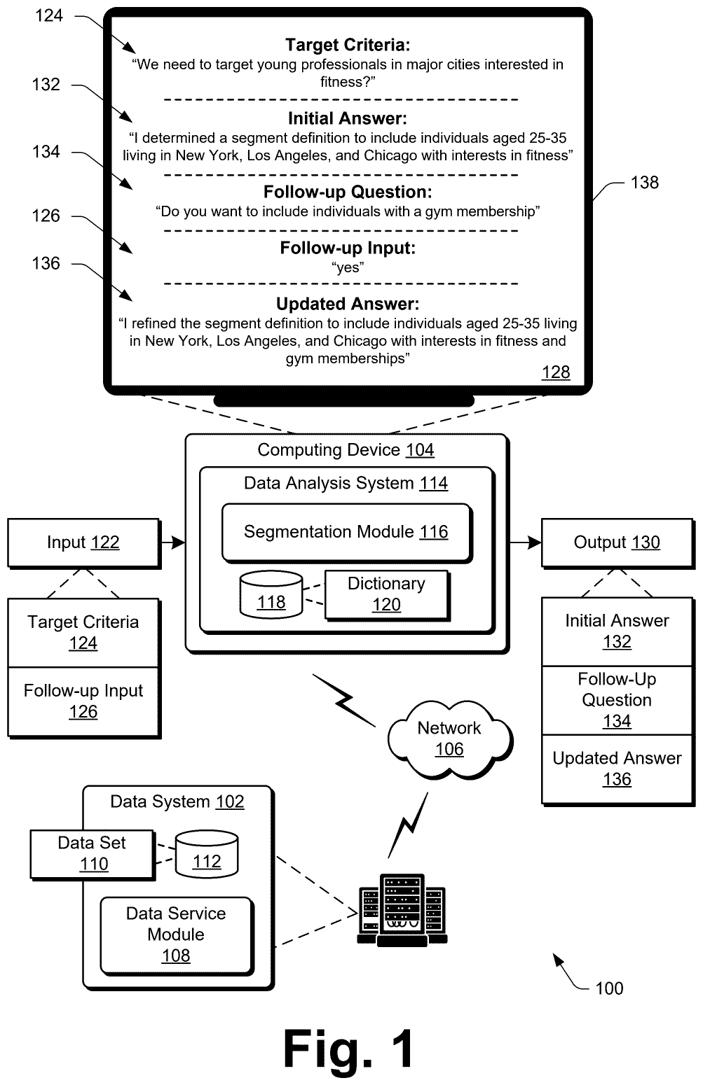

FIG. 1 is an illustration of a digital medium environment 100 in an example implementation that is operable to employ grounding techniques for segmenting datasets using machine-learning models as described herein. The illustrated environment 100 includes a data system 102 and a computing device 104 that are communicatively coupled, one to another, via a network 106.

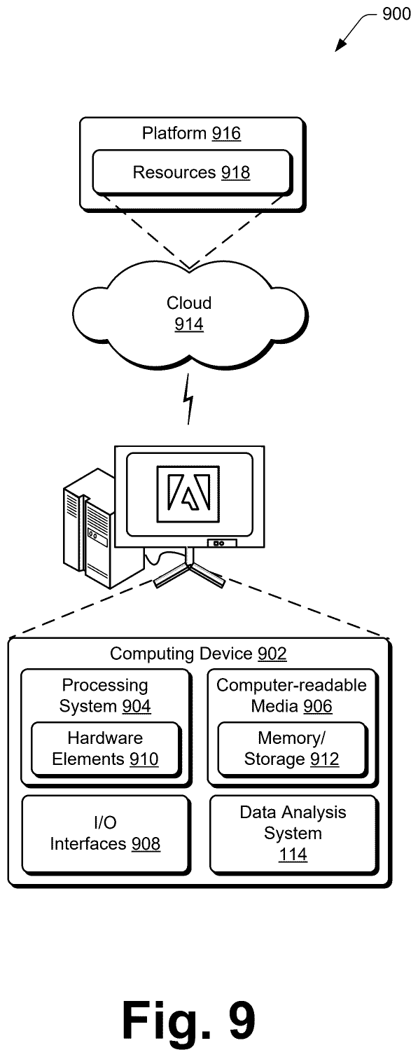

The data system 102 and the computing device 104 are example computing devices that are configurable in a variety of ways. A computing device, for instance, is configurable as a desktop computer, a laptop computer, a mobile device (e.g., assuming a handheld configuration such as a tablet or mobile phone), and so forth. Thus, a computing device ranges from full-resource devices with substantial memory and processor resources (e.g., personal computers and game consoles) to a low-resource device with limited memory and/or processing resources, e.g., mobile devices. Additionally, although separate, individual computing devices are shown and described in instances in the following discussion, each computing device is also representative of a plurality of different devices, such as multiple servers utilized by a business to perform operations “over the cloud” and as further described in relation to FIG. 9.

The data system 102 includes a data service module 108 that is implemented using hardware and software resources (e.g., a processing device and computer-readable storage medium) of the data system 102. The data service module 108 enables one or more data reporting services for querying information from a dataset 110 maintained by a storage device 112. The data reporting services implemented by the data service module 108 are scalable through implementation by the hardware and software resources of the data system 102 to support a variety of functionalities, including data accessibility, data verification, real-time data processing, data analytics, and so forth. Examples of data reporting services associated with the dataset 110 include a data aggregation service, a data storage service, a data management service, a data analytics service, a project management service, a business management service, an accounting service, a marketing or advertising service, and so on.

The dataset 110 is configurable as a knowledge source (e.g., using webpages, digital documents, digital audio, digital video, digital images, and so forth) that is accessible via a variety of entities, examples of which include databases, third-party systems, and so forth. In at least one implementation, the dataset 110 contains data profiles (also referred to as data entries) about current and potential users (e.g., customers) of a system or organization. Data profiles and other information within the dataset 110 is useful to understand user behavior, preferences, and trends and to create targeted marketing campaigns that promote products and services to corresponding users.

A data analysis system 114 of the computing device 104 is configured to access the dataset 110 by communicating with the data service module 108. The data service module 108 is configured to perform a function based on a data query received from the data analysis system 114. A result produced by the data service module 108 based on querying the dataset 110 is output from the data service module 108 as a response to the data query. In this illustrated example, the dataset 110 and the data service module 108 are remotely accessible to the data analysis system 114 via communications exchanged through the network 106. In other examples, the data analysis system 114 includes the storage device 112 and maintains the dataset 110 locally at the computing device 104. When the dataset 110 is implemented locally on the computing device 104, aspects of the data service module 108 are integrated within the data analysis system 114 to enable hardware and software resources on the computing device 104 to access the dataset 110.

A segmentation module 116 (e.g., application, browser, network-enabled application, and so on) of the data analysis system 114 accesses the dataset 110 using the data reporting services implemented by the data service module 108. The segmentation module 116, for instance, causes the computing device 104 to send a data query (e.g., a logical relation of data profile attributes) over the network 106 to the data service module 108 when the dataset 110 is implemented remotely. In another example, when the dataset 110 is implemented locally, the segmentation module 116 queries the dataset 110 directly without communicating on the network 106. A data storage 118 of the data analysis system 114 maintains an attribute dictionary 120 used by the segmentation module 116. As explained below, the attribute dictionary 120 provides a structured and comprehensive overview of the dataset 110 for enabling a machine-learning model of the segmentation module 116 to identify a logical relation of relevant data profile attributes for defining a target segment of the dataset 110.

The segmentation module 116 is configurable to receive an input 122 (e.g., a natural language user input, a machine-generated input) that describes a target criteria 124 for a segment of the dataset 110. As illustrated, the input 122 also includes a follow-up input 126, which as explained below, is received by the computing device 104 to determine whether refinements to an output 130 from the data analysis system 114 are requested (e.g., to satisfy the target criteria 124 inferred from the input 122). Based on the input 122, the segmentation module 116 generates the output 130 (e.g., for display in a user interface 128) from the data analysis system 114. The output 130 includes an initial answer 132 for responding to the input 122, and at least one follow-up question 134 for improving the response to the input 122. When the follow-up input 126 received in the user input 122 affirms the follow-up question 134, the output 130 includes an updated answer 136 that addresses both the target criteria 124 and the follow-up question 134.

As depicted in FIG. 1, the user interface 128 is displayed on a display device 138 of the computing device 104. Within the user interface 128, the target criteria 124, the initial answer 132, the follow-up question 134, the follow-up input 126, and the updated answer 136 are displayed as textual information, e.g., natural language inputs and responses. The user interface 128 is a graphical user interface in the illustrated example. In other examples, the user interface 128 is output as another type of user interface (e.g., an audible user interface through an audio output device, a haptic user interface through a haptic feedback device) or a combination of user interface types enabled by multiple output technologies.

The segmentation module 116 uses a machine-learning model (e.g., an LLM) to deduce segmentation criteria from natural language that describes the target criteria 124 in the input 122 received through the user interface 128. The segmentation module 116 configures the machine-learning model to determine a logical relation of data profile attributes from the dataset 110, which defines a specific group of data profiles that is likely to satisfy the target criteria 124. Accordingly, in implementing the techniques described herein for recommending segments of data profiles, the segmentation module 116 is configured to automatically and comprehensively ground the machine-learning model to the dataset 110.

As previously mentioned, conventional grounding techniques for configuring machine learning models (e.g., neural networks and LLMs) are insufficient. An LLM or other type of machine-learning model that is grounded using conventional techniques is susceptible to misinterpreting the dataset 110 or providing an incomplete or misleading response in the output 130. For example, the token limits of an LLM of the segmentation module 116 prevent conventional prompt-based grounding techniques from being used because the dataset 110 is too large to be included within the input 122 to the LLM. The output 130 of the segmentation module 116 conveys recommended segments of the dataset 110, which satisfy the target criteria 124 and possibly other criteria derived by the segmentation module 116. From systematically prompting the machine-learning model and encouraging user engagement to enhance the grounding process, the segmentation module 116 is operable to improve the accuracy and efficiency of the machine-learning model.

The segmentation module 116 initially grounds the model using the attribute dictionary 120. The attribute dictionary 120 provides a structured and comprehensive overview of the dataset 110 to enable the machine-learning model to identify relevant attributes for segmentation, without having to be trained, re-trained, or prompted to analyze the dataset 110 directly. Within the attribute dictionary 120, descriptions and sample data are specified for distinct attributes prevalent among the data profiles in the dataset 110. The attribute dictionary 120, for instance, includes maximum, minimum, or mean values for numerical attributes to describe the range of data values captured by the various data profiles. For string (e.g., textual) attributes, the attribute dictionary 120 includes representative strings shared among the data profiles. The attribute dictionary 120 organizes the data profiles into distinct categories, classes, or types of information, enabling the model of the segmentation module 116 to derive comprehensive answers based on the dataset 110 without processing each data profile individually.

In response to receiving the input 122, including a natural language input that describes the target criteria 124 for a segment, the segmentation module 116 prompts the machine-learning model to recommend a plurality of dictionary attributes relevant to the target criteria 124. Based on the recommended dictionary attributes, the segmentation module 116 applies similarity search techniques on the target criteria 124 to identify at least one recommended attribute along with a corresponding description and data obtained from the attribute dictionary 120.

The segmentation module 116 prompts the machine-learning model a second time based on the at least one recommended attribute, the description, and the corresponding data to cause the machine-learning model to generate the initial answer 132 as a logical relation of relevant attributes. The machine-learning model generates the initial answer 132 by establishing a logical relation between the at least one recommended attribute and the target criteria 124. The logical relation provided in the initial answer 132 is usable with the data service module 108 to obtain a segment of the dataset 110 that satisfies the target criteria 124. The machine-learning model, for instance, produces the logical relation to include operators and specific attribute values used to create the segment based on the corresponding description and sample data for the recommended attribute. The segmentation module 116 causes the user interface 128 to present the logical relation, including the specific attribute values recommended to form the segment as the initial answer 132.

To enhance the accuracy and comprehensiveness of the machine-learning model's response, the segmentation module 116 automatically triggers the machine-learning model a third time to generate one or more follow-up questions. The follow-up question 134, for instance, is output in the user interface 128. If the user finds the initially defined segment inadequate (e.g., the initial answer 132 is too broad or too narrow), the follow-up question 134 is selectable from the user interface 128 to assist the user in improving the segmentation. When the natural language input is incomplete or lacks specificity available from the dataset 110, the segmentation module 116 manages the user interface 128 to suggest additional user inputs that refine the segment with more specific or additional attribute recommendations.

The segmentation module 116 receives the follow-up input 126, which in this example, indicates a request to refine the initial answer 132. In response to a selection of the follow-up question 134 presented in the user interface 128, the segmentation module 116 invokes the machine-learning model again to further analyze the attribute dictionary 120, derive an updated logical relation, and improve the segmentation initially derived from the natural language of the input 122. The updated answer 136, including the logical relation between the recommended attribute(s) and the target criteria 124, in addition to refinements provided from additional attributes retrieved for answering the follow-up question 134, is output in the user interface 128. This iterative process implemented by the segmentation module 116 to generate the output 130 allows a user of the data analysis system 114 (e.g., a marketing professional) to fine-tune a segment to a specific marketing campaign that encompasses a group of highly relevant data profiles from the dataset 110, which align with the campaign's objectives. By implementing these techniques, the data analysis system 114 and the segmentation module 116 assists users to create precise and dynamic audience segments. The segments are generated efficiently, without training or prompting the machine-learning model directly on thousands or millions of data profiles contained in the dataset 110, and without spending copious amounts of time interacting with the model with further user inputs.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Machine-Learning Model Grounding for Data Segmentation

The following discussion describes machine-learning model grounding techniques for data segmentation utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks.

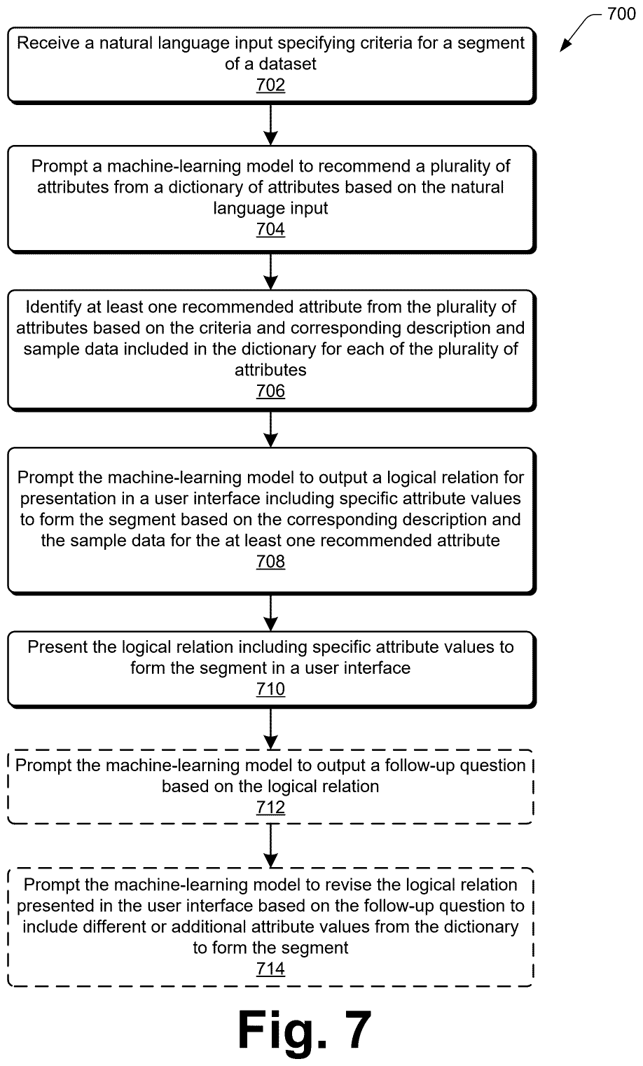

Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm. FIG. 7 is a flow diagram depicting an algorithm 700 as a step-by-step procedure in an example implementation of operations performable for segmenting a large dataset based on the described machine-learning model grounding techniques. In portions of the following discussion, reference will be made in parallel with FIG. 7.

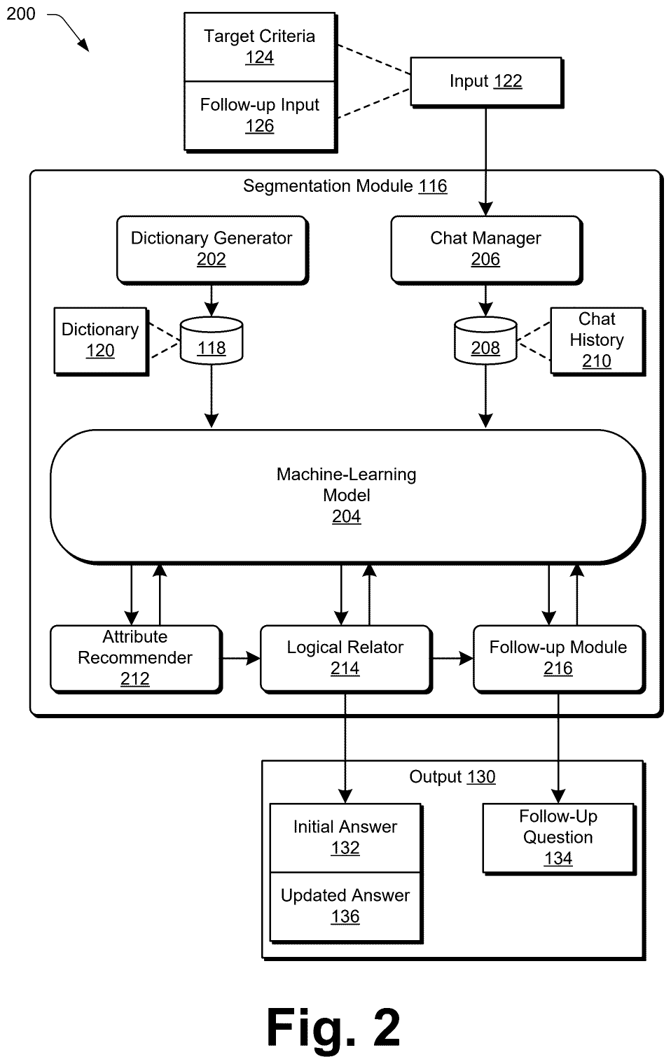

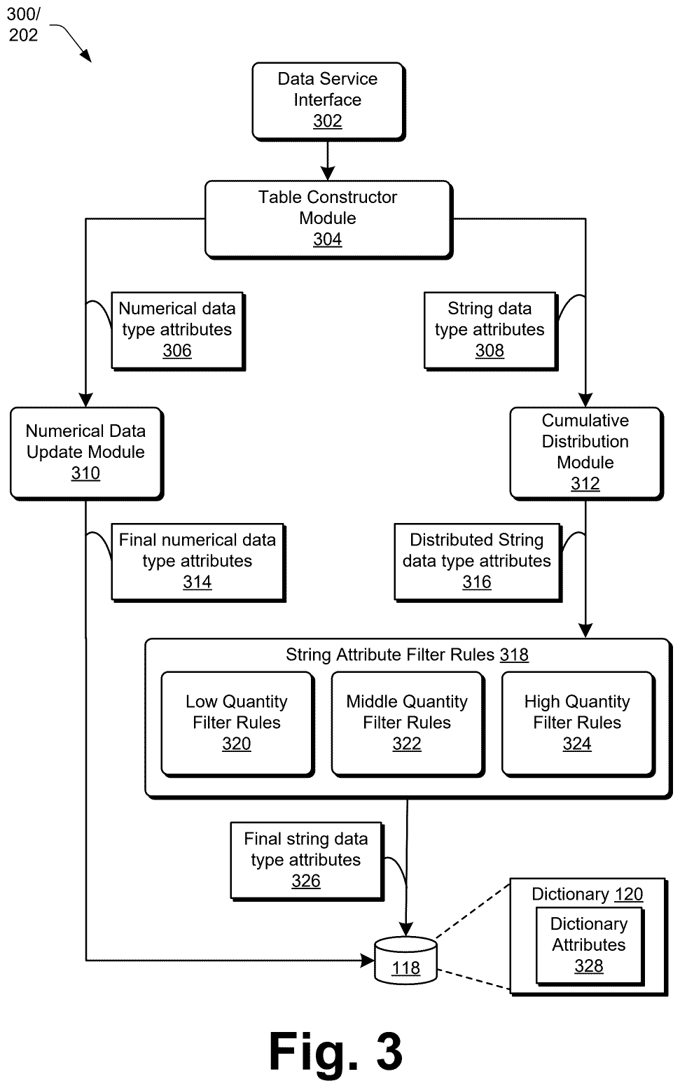

FIG. 2 depicts, in greater detail, an example implementation 200 of the segmentation module 116 from FIG. 1. The segmentation module 116 includes a dictionary generator 202, and this example begins with the dictionary generator 202 creating the dictionary 120, which is stored in the data storage 118. Details of the dictionary generator 202 are illustrated in FIG. 3. In general, the dictionary generator 202 is implemented on the computing device 104 to obtain a subset of the data profiles maintained in the dataset 110, and based on that subset, generate the dictionary 120 of attributes to provide a structured and comprehensive overview of the dataset 110 for identifying relevant attributes for segmentation. For example, the dictionary 120 is a table or list of a plurality of distinct attributes identified among the data profiles included in the subset. The dictionary generator 202 creates the dictionary 120 with a corresponding name, description, and sample data accompanying each attribute.

To improve efficiency in creating and subsequently updating the dictionary 120 when the dataset 110 changes, the dictionary generator 202 produces the dictionary 120 from a statistically significant and randomly selected portion of the dataset 110, while ignoring a remaining portion of the data set 110. For example, the dictionary generator 202 generates the dictionary 120 by randomly obtaining a fixed quantity (e.g., one million) or fixed percentage (e.g., one percent, ten percent, 80 percent) of data profiles in the dataset 110.

The dictionary generator 202 stores the dictionary 120 in the data storage 118 for later use by a machine-learning model 204 included within, or remotely accessible by, the segmentation module 116. The dictionary generator 202 configures the dictionary 120 to support efficient processing as an input to the machine-learning model 204. For example, the dictionary generator 202 limits the list of attributes in the dictionary 120 to include no more than a fixed threshold (e.g., five hundred) of the most frequently used attributes (e.g., appearing in eighty percent) of the data profiles included in the subset.

An LLM of the machine-learning model 204, for instance, receives the dictionary 120 for grounding a prompt input to the LLM by another aspect of the segmentation module 116. A size the dataset 110 may far exceed a token limit of a prompt interface to the LLM. By appropriately limiting a size of the subset and a size of the dictionary 120, the dictionary generator 202 configures the dictionary 120 to be used in grounding future prompts, with reference the dictionary 120, while satisfying token limits of the LLM.

With the dictionary 120 having been created, this example continues with a chat manager 206 of the segmentation module 116 receiving a natural language input 122 specifying the target criteria 124 for a segment of the dataset 110 (block 702). The chat manager 206 is configured to process user inputs received at the user interface 128 to build a chat history 210 associated with the segmentation module 116. The chat history 210 is maintained in the data storage 118 or a different data storage 208 of the computing device 104 and records various types of user engagements with the user interface 128. In one type of user engagement, at least part of the user input 122 is text-based and typed at a graphical or physical keyboard of the computing device 104. In another type of user engagement, at least part of the user input 122 is audio-based and spoken into a microphone of the computing device 104. Another type of user engagement causes at least part of the user input 122 to be visual based, for example, handwritten graphical text input at a touch screen or sign language performed using hand signs captured by a camera, a wearable device, or other type of sensor.

Based on various user engagements with the user interface 128, a natural language interpreter of the chat manager 206 processes the input 122 to append the chat history 210 with information describing the target criteria 124 for a segment of the dataset 110. The chat manager 206 stores the chat history 210 in the data storage 208 for later use by the machine-learning model 204, including configuring the chat history 210 for efficient processing as an input to the machine-learning model 204. For example, the chat manager 206 limits the records of user engagements stored in the chat history 210 to no more than a fixed threshold quantity of records (e.g., five hundred) of the most frequently used words or phrases. Additionally, or alternatively, the chat manager 206 limits the records of user engagements stored in the chat history 210 to no more than a fixed threshold quantity of records (e.g., five hundred) of the most recently used words or phrases. By appropriately limiting a size of the chat history 210, the chat manager 206 configures the chat history 210 for grounding future prompts, with reference the chat history 210, while satisfying token limits of the LLM.

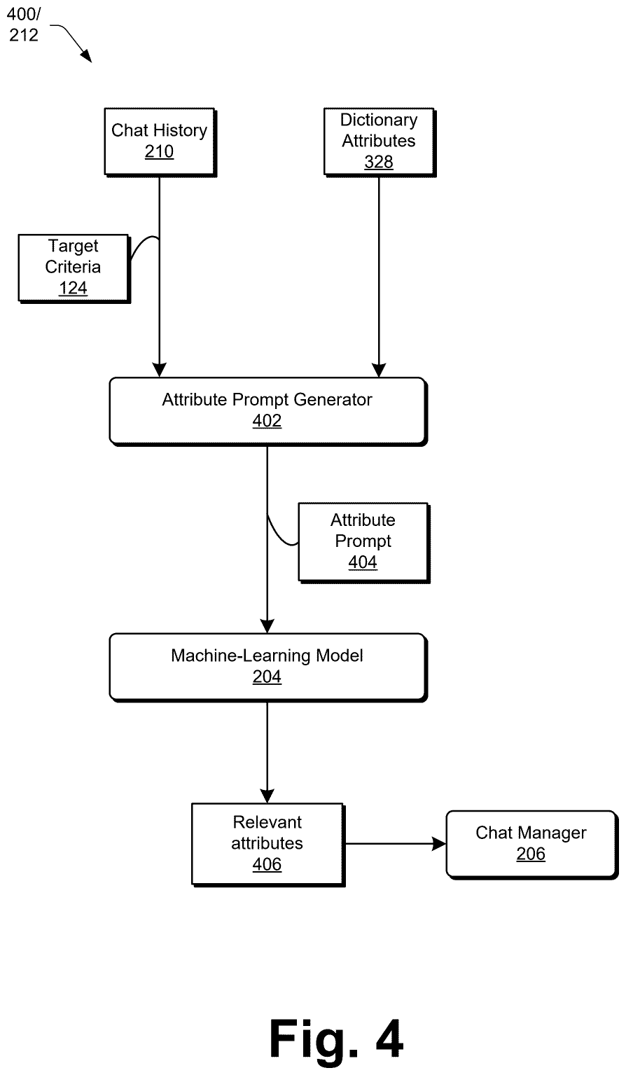

Next in this example depicted in FIG. 2, an attribute recommender 212 of the segmentation module 116 prompts the machine-learning model 204 to recommend a plurality of attributes from the dictionary 120 of attributes based on the natural language input 122 (block 704). Details of the attribute recommender 212 are illustrated in FIG. 4. The attribute recommender 212 generates an attribute prompt based on the target criteria 124, the dictionary 120 (e.g., a list of attribute names), and the chat history 210. The attribute prompt is input into the machine-learning model 204 to request a plurality of attributes from the dictionary 120 that are relevant to the target criteria 124 and the chat history 210. In an example, the chat manager 206 interfaces with the attribute recommender 212 and appends the chat history 210 with information describing the plurality of attributes that are output from the machine-learning model 204.

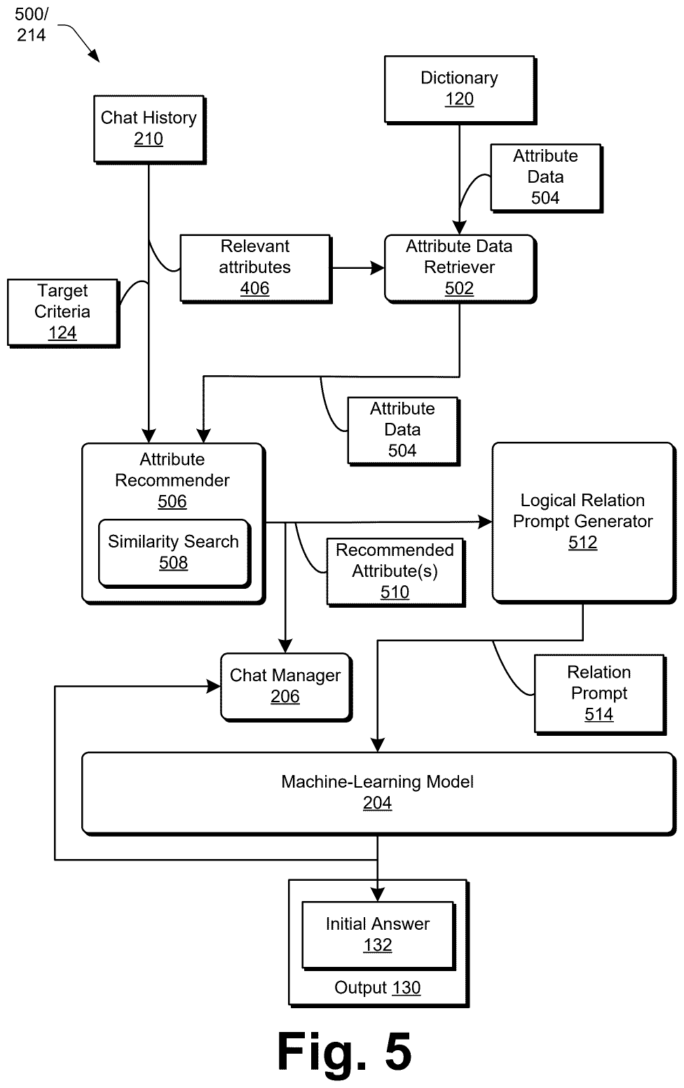

After receiving the plurality of attributes from the machine-learning model 204, this example continues with a logical relator 214 identifying at least one recommended attribute from the plurality of attributes based on the target criteria 124 and corresponding description and sample data included in the dictionary 120 for each of the plurality of attributes (block 706). The at least one recommended attribute is identified, for instance, based on performing a similarity search between the target criteria 124 and corresponding description and sample data included in the dictionary 120 for each of the plurality of attributes appended to the chat history 210. Details of the logical relator 214 are illustrated in FIG. 5. In general, the logical relator 214 determines at least one recommended attribute from the plurality and enhances the at least one attribute based on the corresponding description and sample data retrieved from the dictionary 120 for that attribute. The logical relator 214 builds a relation prompt for input to the machine-learning model 204 using at least one recommended attribute and the corresponding description and sample data.

The logical relator 214 prompts the machine-learning model 204 to output a logical relation for presentation in the user interface 128 including specific attribute values to form the segment based on the corresponding description and the sample data for the at least one recommended attribute (block 708). For example, the relation prompt is input to the machine-learning model 204 to cause the machine-learning model 204 to output a logical relation as the initial answer 132 included in the output 130.

The logical relator 214 presents the logical relation including specific attribute values to form the segment in a user interface (block 710). For example, the chat manager 206 causes the initial answer 132 to be presented in the user interface 128 as depicted in FIG. 1. The chat manager 206 constructs the initial answer 132 to convey the logical relation by describing (e.g., in text) specific attribute values to be used for querying the dataset 110 to obtain the segment.

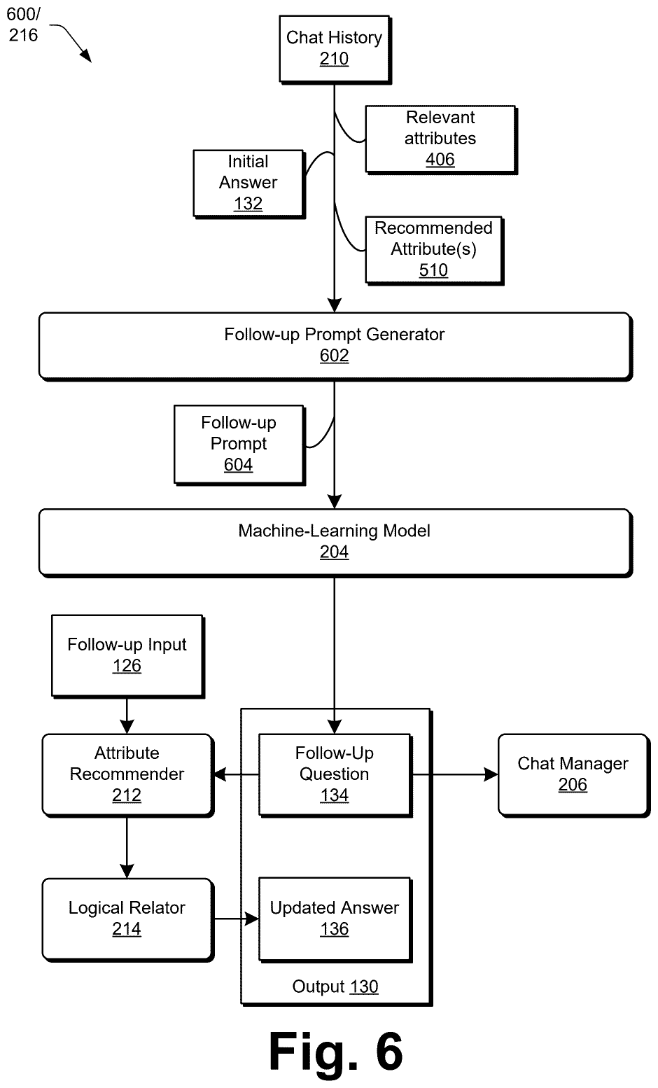

To enhance the accuracy and comprehensiveness of the output 130 from the machine-learning model 204, this example continues with a follow-up module 216 of the segmentation module 116 automatically invoking the machine-learning model 204 to request one or more follow-up questions related to the chat history 210, the recommended attributes, and the logical relation in the initial answer 132. The follow-up module 216, optionally, prompts the machine-learning model 204 to output a follow-up question 134 based on the logical relation (block 712). Details of the follow-up module 216 are illustrated in FIG. 6. The follow-up question 134 is presented in the user interface 128. Based on the follow-up input 126 received by the chat manager 206 in the input 122, the follow-up question 134 is selectable from the user interface 128 to cause the follow-up module 216 to further assist the user in improving the output 130.

When the input 122 is incomplete or lacks specificity available from the dataset 110, the follow-up module 216 communicates with the chat manager 206 to control the user interface 128 to suggest a revised logical relation (e.g., with fewer or additional attributes and fewer or additional attribute values) that refines the segment to the satisfaction of the user. To complete this example, optionally, the follow-up module 216 prompts the machine-learning model 204 to revise the logical relation presented in the user interface 128 based on the follow-up question 134 to include different or additional attribute values from the dictionary 120 to form the segment (block 714). In response to a selection of one or more follow-up questions presented in the user interface 128, the segmentation module 116 invokes the machine-learning model 204 again to further analyze the dictionary 120, derive an updated logical relation as the updated answer 136, and improve the segmentation defined by the initial answer 132. This iterative process performed by the segmentation module 116 allows a marketing professional or other user of the computing device 104 to provide additional inputs for fine-tuning a segment to a specific marketing campaign that encompasses a group of highly relevant data profiles from the dataset 110, which are aligned with the campaign's objectives.

FIG. 3 depicts an example implementation 300 of the dictionary generator 202 of FIG. 2 in greater detail as employing techniques described herein for grounding machine-learning models for segmenting datasets. In the illustrated example of FIG. 3, the dictionary generator 202 includes a data service interface 302 that enables communication between the segmentation module 116 and the data service module 108. Based on the communication, the data service interface 302 queries the data service module 108 to obtain a subset of data profiles maintained in the dataset 110. For example, the data service interface 302 determines if the dataset 110 has fewer data profiles than a threshold (e.g., one million). If the data profiles number less than the threshold, the data service interface 302 obtains each of the data profiles. Otherwise, the data service interface 302 requests a random sample of the data profiles (e.g., one million) from the dataset 110. The data service interface 302 helps ensure that the dictionary 120 eventually constructed from the dataset 110 is manageable and of sufficient size to enable efficient processing while also a comprehensive representation of the attributes in the dataset 110.

A table constructor module 304 uses the information obtained by the data service interface 302 to generate a table or other data structure that includes a list of attributes along with corresponding data types and attribute values (e.g., strings, numbers). The table constructor module 304 separates the subset of the dataset 110 into numerical data type attributes 306 and string data type attributes 308. The table constructor module 304 identifies each of the distinct attributes that are the numerical data type attributes 306 and identifies each of the distinct attributes that are the string data type attributes 308.

Based on the numerical data type attributes 306, a numerical data update module 310 generates final numerical data type attributes 314, which provide a comprehensive summary of the numerical data captured by the numerical data type attributes 306. The numerical data update module 310 determines sample data (e.g., one or more of a respective minimum, a respective maximum, and a respective mean) for each of the numerical data type attributes 306 and appends the sample data to the final numerical data type attributes 314 prior to including each of the final numerical data type attributes 314 in the dictionary 120.

The dictionary generator 202 handles the string data type attributes 308 differently than the numerical data type attributes 306. To provide a comprehensive summary of the string data captured by the string data type attributes 308, a cumulative distribution module 312 determines a respective cumulative distribution for each of the string data type attributes 308. Distributed string data type attributes 316 are output from the cumulative distribution module 312 after each is assigned a cumulative distribution value based on a quantity of times that string data type attribute appears in the subset of the dataset 110. The cumulative distribution enables the dictionary generator 202 to limit a quantity of the string data type attributes 308 and corresponding distinct strings that are stored as sample data in the dictionary 120. In at least one example, the distributed string data type attributes 316 include fewer attributes than the string data type attributes 308. The cumulative distribution module 312 excludes from the distributed string data type attributes 316 a group of the string data type attributes 308 that have respective cumulative distributions that do not satisfy a cumulative distribution threshold (e.g., eighty percent).

The dictionary generator 202 applies string attribute filter rules 318 to the distributed string data type attributes 316 to further limit a quantity of final string data type attributes 326 and corresponding distinct strings that are stored in the dictionary 120. For example, after the cumulative distribution module 312 excludes the group of the distinct attributes from the dictionary, the string attribute filter rules 318 are used to determine the total quantity of the distributed string data type attributes 316. Depending on the total quantity, either low quantity filter rules 320, middle quantity filter rules 322, or high quantity filter rules 324 are applied to derive the final string data type attributes 326. Responsive to determining that the total quantity is greater than a maximum quantity threshold (e.g., five hundred), the high quantity filter rules 324 cause the total quantity of the final string data type attributes 326 that are included in the dictionary 120 to be equal to or otherwise satisfy the maximum quantity threshold. Responsive to determining that the total quantity is less than the maximum quantity threshold but greater than a minimum quantity threshold (e.g., ten), the middle quantity filter rules 322 cause the total quantity of the final string data type attributes 326 that are included in the dictionary 120 to be the same as the quantity of the distributed string data type attributes 316. Responsive to determining that the total quantity is less than the minimum quantity threshold (e.g., ten), the low quantity filter rules 320 cause the total quantity of the final string data type attributes 326 that are included in the dictionary 120 to be equal to the string data type attributes 308. For example, after the cumulative distribution module 312 excludes the group of the distinct attributes from the dictionary to limit the string attributes to be the top eighty percent, the low quantity filter rules 320 re-include the previously excluded group of the string data type attributes 308 among the final string data type attributes 326 that are added to the dictionary 120.

With the dictionary 120 created, dictionary attributes 328 and corresponding sample data is available to the segmentation module 116 for recommending segmentations of the dataset 110. As one example, the dictionary attributes 328 include a string data type attribute “workaddress.countrycode” having sample data including a plurality of strings corresponding to “US, CA, MX, and ES.” As an example of a numerical data type attribute included in the dictionary attributes 328, the dictionary 120 includes an attribute “person.birthyear” having sample data including a numerical summary corresponding to “Minimum—1960.0, Maximum—2000.0, and Mean—1984.25.”

FIG. 4 depicts an example implementation 400 of the attribute recommender 212 of FIG. 2 in greater detail as employing techniques described herein for grounding machine-learning models for segmenting datasets. An attribute prompt generator 402 generates an attribute prompt 404 based on one or more of the target criteria 124, the dictionary attributes 328, and the chat history 210. For example, the attribute prompt 404 includes a request for the machine-learning model 204 to identify a plurality of attributes from the dictionary attributes 328 that are relevant to the target criteria 124 and/or the chat history 210. The dictionary attributes 328, the target criteria 124, and the chat history 210 are, for instance, included in the prompt interface to the machine-learning model 204 along with the request for relevant attributes 406. The machine-learning model 204 responds to the request by outputting the relevant attributes 406. In this example, the chat manager 206 interfaces with the attribute recommender 212 to receive the relevant attributes 406 and appends the chat history 210 with information describing the relevant attributes 406.

FIG. 5 depicts an example implementation 500 of the logical relator 214 of FIG. 2 in greater detail as employing techniques described herein for grounding machine-learning models for segmenting datasets. In this example, after receiving the relevant attributes 406 from the machine-learning model 204, an attribute data retriever 502 of the logical relator 214 obtains attribute data 504 from the dictionary 120 to enhance the relevant attributes 406 with information used to determine a recommended attribute. A corresponding description and sample data included in the dictionary 120 is retrieved as the attribute data 504 for each of the relevant attributes 406. A similarity search 508 is performed by the attribute recommender 506 to identify at least one recommended attribute 510 from the relevant attributes 406. For example, the similarity search 508 uses the target criteria 124 and/or the chat history 210, in addition to the attribute data 504 (e.g., corresponding descriptions and sample data included in the dictionary 120 for each of the relevant attributes 406) to determine one or more recommended attributes 510 that are more likely to be useful for segmenting the dataset 110 based on the target criteria 124. In one or more examples, the recommended attribute(s) 510 are appended to the chat history 210 through the chat manager 206.

A logical relation prompt generator of the logical relator 214 builds a relation prompt 514 for input to the machine-learning model 204 using the recommended attribute(s) 510 and the attribute data 504. For example, the relation prompt 514 includes a request for the machine-learning model 204 to identify a logical relation for presentation in the user interface 128 as the initial answer 132, including specific attribute values to form the segment based on the attribute data 504 (e.g., corresponding description and the sample data) for the recommended attribute(s) 510. The relation prompt 514 is input to the machine-learning model 204 to cause the machine-learning model 204 to output a logical relation as the initial answer 132 included in the output 130. In one or more examples, the initial answer 132 is appended to the chat history 210 through the chat manager 206.

FIG. 6 depicts an example implementation 600 of the follow-up module 216 of FIG. 2 in greater detail as employing techniques described herein for grounding machine-learning models for segmenting datasets. To enhance the accuracy and comprehensiveness of the output 130, the follow-up module 216 automatically invokes the machine-learning model 204 to request one or more follow-up questions 134 related to the chat history 210, which has been appended with the relevant attributes 406. Based on the follow-up input 126 received from the user interface 128, the follow-up module 216 determines whether to invoke the attribute recommender 212 and the logical relator 214 to derive the updated answer 136 and address the follow-up question 134. For example, in response to presenting the follow-up question 134 in the user interface 128, the segmentation module 116 receives the follow-up input 126. When the follow-up input 126 indicates “no” that the user is not interested in the updated answer 136 to the follow-up question 134, the attribute recommender 212 and the logical relator 214 refrain from deriving the updated answer 136. When the follow-up input 126 indicates “yes” that the user is interested in the updated answer 136 to the follow-up question 134, the attribute recommender 212 and the logical relator 214 are tasked with deriving the updated answer 136 in a similar manner as the initial answer 132.

To generate the follow-up question 134, the follow-up module 216 includes a follow-up prompt generator 602. The follow-up prompt generator 602 produces a follow-up prompt 604 for input to the machine-learning model 204 using the initial answer 132, the relevant attributes 406, and the recommended attributes 510. For example, the follow-up prompt 604 includes a request for the machine-learning model 204 to identify one or more questions for presentation in the user interface 128 that suggest possible refinements to the logical relation provided in the initial answer 132, including additional or different attributes, attribute values, etc. to form the segment of the dataset 110 data profiles. The follow-up prompt 604 is input to the machine-learning model 204 to cause the machine-learning model 204 to output the follow-up question 134 included in the output 130. In one or more examples, the follow-up question 134 is appended to the chat history 210 through the chat manager 206.

Rather than derive the updated answer 136 based on the target criteria 124 originally received in the input 122, the attribute recommender 212 and the logical relator 214 process the follow-up question 134 to refine the logical relation output in the initial answer 132 and incorporate information that answers the follow-up question 134. For example, the attribute recommender 212 and the logical relator 214 are used to identify at least one additional or different recommended attribute 510 from the additional or different attributes specified in the follow-up question 134. The additional or different recommended attribute 510 is determined by the logical relator 214 based on a similarity search between the follow-up question 134 and additional corresponding description and sample data included in the dictionary 120 for each of the additional or different relevant attributes 406 identified by the attribute recommender 212. Then, the logical relator 214 prompts the machine-learning model 204 to output the revised logical relation within the updated answer 136 based on the follow-up question 134 and the additional corresponding description and sample data for each of the additional or different attributes 510.

In summary, the follow-up module 216 determines the follow-up question 134 to solicit user feedback about whether the logical relation and the proposed segment definition appear accurate, or whether more details or clarification is requested. The follow-up input 126 allows the user to selectively engage the follow-up module 216 and in one or more implementations, select one or more follow-up questions to be answered.

To ensure the updated answer 136 includes accurate, complete, and relevant information, the follow-up module 216 compares the updated answer 136 with the dictionary 120. The follow-up module 216 rechecks attributes and attribute values contained in the logical relation of the updated answer 136 to confirm that the attributes and corresponding values match the dictionary attributes 328 and the corresponding sample data maintained in the dictionary 120 for those attributes.

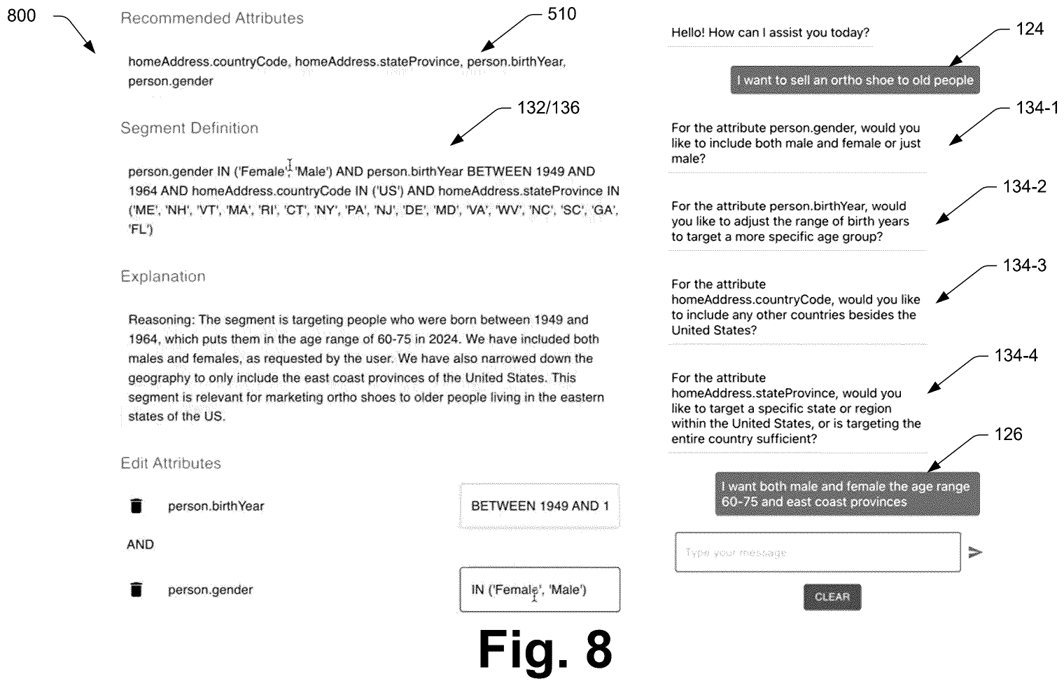

FIG. 8 depicts an example graphical user interface 800 controlled by the data analysis system of FIG. 1 to employ techniques described herein for grounding machine-learning models for segmenting datasets. The graphical user interface 800 is an example of the user interface 128 and is managed by the segmentation module 116. For example, the chat manager 206 controls the right side of the user interface 800 to provide a chat region for receiving the user input 122, including the target criteria 124 and the follow-up input 126, as well as for presenting the follow-up question 134. In this example, there are four follow-up questions 134-1 through 134-4. The follow-up input 126 includes text that clarifies a user answer to each follow-up question 134-1, 134-2, and 134-4. The follow-up input 126, is silent with regard to the follow-up question 134-3, which is construed by the follow-up module 216 as an indirect answers to that follow-up question.

The output 130 is presented in the left side of the graphical user interface 800. For example, a recommended attribute section, a segment definition section, and an explanation section are shown. The recommended attribute section presents the recommended attributes 510. The segment definition section presents the initial answer 132, and then presents the updated answer 136 to convey the logical relation between the target criteria 124, the recommended attributes 510, and the follow-up input 126.

In one or more variations, the recommended attributes 510 are editable through further user inputs. For example, the lower-left section of the graphical user interface 800 includes graphical elements to allow manual user adjustments of the recommended attributes 510 presented in the recommended attribute section.

### Example System and Device

FIG. 9 illustrates an example system 900, generally, that includes an example computing device 902 that is representative of one or more computing systems and/or devices that implement the various techniques described herein. This is illustrated through inclusion of the data analysis system 114. The computing device 902 is configurable, for example, as a server of a service provider, a device associated with a client (e.g., a client device), an on-chip system, and/or any other suitable computing device or computing system.

The example computing device 902 as illustrated includes a processing device 904, one or more computer-readable media 906, and one or more I/O interface 908 that are communicatively coupled, one to another. Although not shown, the computing device 902 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 904 is representative of functionality to perform one or more operations using hardware. Accordingly, the processing device 904 is illustrated as including hardware element 910 that is configurable as processors, functional blocks, and so forth. This includes implementation in hardware as an application specific integrated circuit or other logic device formed using one or more semiconductors. The hardware elements 910 are not limited by the materials from which they are formed, or the processing mechanisms employed therein. For example, processors are configurable as semiconductor(s) and/or transistors (e.g., electronic integrated circuits (ICs)). In such a context, processor-executable instructions are electronically executable instructions.

The computer-readable storage media 906 is illustrated as including memory/storage 912 that stores instructions that are executable to cause the processing device 904 to perform operations. The computer-readable storage medium is configured for storing instructions that, responsive to execution by the processing device, causes the processing device to perform operations. The memory/storage 912 represents memory/storage capacity associated with one or more computer-readable media. The memory/storage 912 includes volatile media (such as random access memory (RAM)) and/or nonvolatile media (such as read only memory (ROM), Flash memory, optical disks, magnetic disks, and so forth). The memory/storage 912 includes fixed media (e.g., RAM, ROM, a fixed hard drive, and so on) as well as removable media (e.g., Flash memory, a removable hard drive, an optical disc, and so forth). The computer-readable media 906 is configurable in a variety of other ways as further described below.

Input/output interface(s) 908 are representative of functionality to allow a user to enter commands and information to computing device 902, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 902 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 902. By way of example, and not limitation, computer-readable media includes “computer-readable storage media” and “computer-readable signal media.”

“Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable, and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the information and are accessible by a computer.

“Computer-readable signal media” refers to a signal-bearing medium that is configured to transmit instructions to the hardware of the computing device 902, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 910 and computer-readable media 906 are representative of modules, programmable device logic and/or fixed device logic implemented in a hardware form that are employed in some examples to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 910. The computing device 902 is configured to implement particular instructions and/or functions corresponding to the software and/or hardware modules. Accordingly, implementation of a module that is executable by the computing device 902 as software is achieved at least partially in hardware, e.g., through use of computer-readable storage media and/or hardware elements 910 of the processing device 904. The instructions and/or functions are executable/operable by one or more articles of manufacture (for example, one or more computing devices 902 and/or processing devices 904) to implement techniques, modules, and examples described herein.

The techniques described herein are supported by various configurations of the computing device 902 and are not limited to the specific examples of the techniques described herein. This functionality is also implementable all or in part through use of a distributed system, such as over a “cloud”914 via a platform 916 as described below.

The cloud 914 includes and/or is representative of a platform 916 for resources 918. The platform 916 abstracts underlying functionality of hardware (e.g., servers) and software resources of the cloud 914. The resources 918 include applications and/or data that can be utilized while computer processing is executed on servers that are remote from the computing device 902. Resources 918 can also include services provided over the Internet and/or through a subscriber network, such as a cellular or Wi-Fi network.

The platform 916 abstracts resources and functions to connect the computing device 902 with other computing devices. The platform 916 also serves to abstract scaling of resources to provide a corresponding level of scale to encountered demand for the resources 918 that are implemented via the platform 916. Accordingly, in an interconnected device example, implementation of functionality described herein is distributable throughout the system 900. For example, the functionality is implementable in part on the computing device 902 as well as via the platform 916 that abstracts the functionality of the cloud 914.

In implementations, the platform 916 employs a “machine-learning model” that is configured to implement the techniques described herein. A machine-learning model refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
receiving, by a processing device, a natural language input specifying criteria for a segment of a dataset;
prompting, by the processing device, a machine-learning model to recommend a plurality of attributes from a dictionary of attributes based on the natural language input, the dictionary of attributes specifying corresponding descriptions and sample data for a plurality of distinct attributes identified among a plurality of data profiles included in the dataset;
identifying, by the processing device, at least one recommended attribute from the plurality of attributes based on the criteria and the corresponding description and sample data included in the dictionary for each of the plurality of attributes;
prompting, by the processing device, the machine-learning model to output a logical relation including specific attribute values to form the segment based on the corresponding description and the sample data for the at least one recommended attribute; and
presenting, by the processing device, the logical relation including specific attribute values to form the segment in a user interface.

2. The method of claim 1, further including:
prompting the machine-learning model to output a follow-up question based on the logical relation; and
presenting the follow-up question in the user interface.

3. The method of claim 2, further including:
receiving a user input to the user interface in response to presenting the follow-up question;
responsive to determining that the user input indicates a request for an answer to the follow-up question, prompting the machine-learning model to revise the logical relation based on the follow-up question to include different or additional attribute values that form the segment; and
presenting a revised logical relation in the user interface including the different or additional attribute values to form the segment.

4. The method of claim 3, wherein prompting the machine-learning model to revise the logical relation includes:
prompting the machine-learning model to recommend additional or different attributes from the dictionary of attributes based on the follow-up question;
identifying, by the processing device, at least one additional or different recommended attribute from the additional or different attributes based on a similarity search between the follow-up question and additional corresponding description and sample data included in the dictionary for each of the additional or different attributes; and
prompting, by the processing device, the machine-learning model to output the revised logical relation based on the follow-up question and the additional corresponding description and sample data for each of the additional or different attributes.

5. The method of claim 1, further including:
appending the natural language input to a chat history associated with the machine-learning model; and
prompting the machine-learning model to recommend the plurality of attributes based further on the chat history.

6. The method of claim 1, further including:
appending the plurality of attributes to a chat history associated with the machine-learning model; and
prompting the machine-learning model to output the logical relation including the specific attribute values to form the segment based further on the chat history.

7. The method of claim 1, wherein identifying the at least one recommended attribute from the plurality of attributes includes identifying the at least one recommended attribute based on a similarity search between the criteria and the corresponding description and sample data included in the dictionary for each of the plurality of attributes.

8. A system comprising:
a data storage configured to maintain a dataset having data profiles each associated with one or more attributes; and
a processing device communicatively coupled to the data storage to perform operations that include:
obtaining a subset of the data profiles maintained in the dataset;
generating a dictionary of attributes that specifies corresponding descriptions and sample data for a plurality of distinct attributes identified among the data profiles included in the subset;
receiving a natural language input specifying criteria for a segment of the dataset;
prompting a machine-learning model to recommend a plurality of attributes from the dictionary of attributes based on the natural language input;
identifying at least one recommended attribute from the plurality of attributes based on the criteria and a corresponding description and sample data included in the dictionary for each of the plurality of attributes; and
prompting the machine-learning model to output a logical relation including specific attribute values to form the segment based on the corresponding description and the sample data for the at least one recommended attribute.

9. The system of claim 8, the operations further including:
prompting the machine-learning model to output a follow-up question based on the logical relation; and
prompting the machine-learning model to revise the logical relation to include different or additional attribute values that form the segment.

10. The system of claim 9, the operations for prompting the machine-learning model to revise the logical relation including:
prompting the machine-learning model to recommend additional or different attributes from the dictionary of attributes based on the follow-up question;
identifying at least one additional or different recommended attribute from the additional or different attributes based on a similarity search between the follow-up question and additional corresponding description and sample data included in the dictionary for each of the additional or different attributes; and
prompting the machine-learning model to output the revised logical relation based on the follow-up question and the additional corresponding description and sample data for each of the additional or different attributes.

11. The system of claim 9, further including:
appending the follow-up question to a chat history associated with the machine-learning model; and
prompting the machine-learning model to revise the logical relation based further on the chat history.

12. The system of claim 8, further including:
appending the natural language input to a chat history associated with the machine-learning model; and
prompting the machine-learning model to recommend the plurality of attributes based further on the chat history.

13. The system of claim 8, further including:
appending the plurality of attributes to a chat history associated with the machine-learning model; and
prompting the machine-learning model to output the logical relation including the specific attribute values to form the segment based further on the chat history.

14. The system of claim 8, wherein the machine-learning model includes a large language model, wherein a size the dataset exceeds a token limit of a prompt interface to the large language model.

15. A non-transitory computer-readable medium storing executable instructions, which when executed by a processing device, cause the processing device to perform operations comprising:
obtaining a subset of data profiles maintained in a dataset;
generating a dictionary of attributes that specifies corresponding descriptions and sample data for a plurality of distinct attributes identified among the data profiles included in the subset;
prompting a machine-learning model to output one or more recommend attributes from the dictionary that form a segment of the data profiles inferred from a natural language input; and
presenting the one or more recommend attributes in a user interface.

16. The non-transitory computer-readable medium of claim 15, wherein the operations further include:
identifying each of the distinct attributes that is a numerical data type; and
including one or more of a respective minimum, a respective maximum, and a respective mean as the sample data specified in the dictionary for each of the distinct attributes that is the numerical data type.

17. The non-transitory computer-readable medium of claim 15, wherein the operations further include:
identifying each of the distinct attributes that is a string data type; and
including at least one respective string as the sample data specified in the dictionary for each of the distinct attributes that is the string data type.

18. The non-transitory computer-readable medium of claim 17, wherein the operations further include:
determining a respective cumulative distribution for each of the distinct attributes that is the string data type, the respective cumulative distribution indicating a quantity of times that distinct attribute appears among the subset of data profiles; and
excluding, from the dictionary, a group of the distinct attributes that are the string data type and have respective cumulative distributions that do not satisfy a cumulative distribution threshold.

19. The non-transitory computer-readable medium of claim 18, wherein the operations further include:
after excluding the group of the distinct attributes from the dictionary, determining a total quantity of the distinct attributes in the dictionary that are the string data type; and
responsive to determining that the total quantity is less than a minimum quantity threshold, re-including the group of the distinct attributes in the dictionary.

20. The non-transitory computer-readable medium of claim 18, wherein the operations further include:
after excluding the group of the distinct attributes from the dictionary, determining a total quantity of the distinct attributes in the dictionary that are the string data type; and
responsive to determining that the total quantity is greater than a maximum quantity threshold, reducing, based on the respective cumulative distributions, the total quantity of the distinct attributes in the dictionary that are the string data type to satisfy the maximum quantity threshold.
